(19) United States
(12) Patent Application Publication
(10) Pub. No.: US 2005/0265395 A1
(43) Pub. Date: Dec. 1, 2005

(54) Multimedia service system for portable devices using hardware transcoder

(75) Inventors: Jae Ho Kim, Pyung Taek-si (KR); Kwang-Ho Won, Pyung Taek-si (KR); Tae-Ho Hwang, Pyung Taek-si (KR); Sang Shin Lee, Pyung Taek-si (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTRONICS TECHNOLOGY INSTITUTE

(21) Appl. No.: 10/976,782

(22) Filed: Nov. 1, 2004

(30) Foreign Application Priority Data
May 29, 2004 (KR) 10-2004-0038702

(51) Int. Cl. H04J 1/00

(52) U.S. Cl. 370/485

(57) ABSTRACT

The present invention relates to a system for providing a multimedia service to a portable device. The multimedia service system of the present invention includes a multimedia source, a hardware transcoder, an interface unit, a storage unit and a portable device. The multimedia source provides multimedia contents including video and/or audio data. The hardware transcoder converts the multimedia contents into contents having a format suitable for a display device of the portable device. The interface unit transmits the contents converted by the transcoder. The storage unit stores therein the contents received through the interface unit. The portable device receives the contents from the storage unit and displays the contents. The transcoder changes at least one of video and/or audio formats, a bandwidth (data rate), a frame rate and a resolution of the contents provided from the multimedia source. Accordingly, the present invention can provide multimedia contents most suitable for a portable device having a relatively low display capability.

### RELATED APPLICATIONS

The present disclosure relates to subject matter contained in priority Korean Application No. 10-2004-0038702, filed on 29 May 2004, which is herein expressly incorporated by reference in its entirety.

### BACKGROUND OF THE INVENTION

1. Field of the Invention

The present invention relates, in general, to a multimedia service provided through portable devices and, more particularly, to a system for converting multimedia contents so as to be suitable for respective portable devices and transmitting and/or playing the converted multimedia contents.

2. Description of the Related Art

Generally, portable devices collectively refer to various portable appliances, such as mobile phones, Personal Digital Assistants (PDAs), notebook computers and notepads. Such portable devices include various types of devices, and are considerably different in their computing and display capabilities. However, a multimedia service for conventional portable devices does not consider performance differences, thus causing the following problems.

That is, as in the case of a multimedia service using the computing capability of a portable device without transcoding multimedia contents, a business model of allowing multimedia contents to be stored in a portable device without the accommodating the high resolution multimedia contents that cannot be serviced by a corresponding device may result in wasting a considerable storage space.

Further, in order to play high resolution multimedia data at low resolution supported by a corresponding portable device, a large computing capability is required.

Further, in order for a single portable device to support various formats of multimedia contents, the portable device should be equipped with various coders/decoders (codecs) and players. Accordingly, a large number of functions and a high computing capability are required for the portable device, thus increasing costs.

Further, even in the prior art, there is a multimedia service for portable devices, including functions of partially converting multimedia contents in a software manner. However, a range of conversion is limited, and a transcoding time increases due to an excessive computations when software transcoding is used, so that there is a difficulty in utilizing multimedia contents of large size. Since the software transcoding is generally performed through a personal computer, and a load of the personal computer increases during the transcoding, many restrictions are imposed in utilizing the computer during the transcoding.

### SUMMARY OF THE INVENTION

Accordingly, the present invention has been made keeping in mind the above problems occurring in the prior art, and an object of the present invention is to provide the basic configuration of a multimedia service system using a hardware transcoder.

Another object of the present invention is to provide a multimedia service system using a hardware transcoder for computer systems or set-top boxes, which employs the basic configuration.

A further object of the present invention is to provide a real time broadcasting and multimedia service system using the basic configuration.

In accordance with a first aspect of the present invention, there is provided a multimedia service system for providing a multimedia service to at least one portable device, comprising a multimedia source providing multimedia contents including video and/or audio data, a hardware transcoder converting the multimedia contents into contents having a format suitable for a display device of the portable device, an interface unit transmitting the contents converted by the transcoder, a storage unit storing therein the contents received through the interface unit, and the portable device receiving the contents from the storage unit and displaying the contents. Preferably, the transcoder may change at least one of video and/or audio formats, a bandwidth (data rate), a frame rate and a resolution of the contents provided from the multimedia source.

In accordance with a second aspect of the present invention, there is provided a multimedia service system for providing a multimedia service to a portable device using a hardware transcoder interworking with a computer or a set-top box, comprising a multimedia source providing multimedia contents including video and/or audio data, the hardware transcoder for the computer or the set-top box converting the multimedia contents into contents having a format suitable for a display device of the portable device, an interface unit transmitting the contents converted by the transcoder, and the portable device receiving the contents from the interface unit and displaying the contents.

In accordance with a third aspect of the present invention, there is provided a multimedia service system for providing a device-optimized multimedia service using a hardware transcoder, comprising a multimedia source providing multimedia contents including video and/or audio data, a hardware transcoder converting the contents into contents having formats suitable for display capabilities of portable and fixed devices in real time, an interface unit transmitting the contents converted by the transcoder so as to be suitable for the portable device in real time, and a multimedia service server transmitting the contents converted by the transcoder so as to be suitable for the fixed device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the basic configuration of a multimedia service system using a hardware transcoder according to the present invention;

FIG. 2 is a view showing a multimedia service model for portable devices using a hardware transcoder for computer systems according to an embodiment of the present invention;

FIG. 3 is a view showing the user interface screen of a multimedia service control program for portable devices using a hardware transcoder for computer systems according to an embodiment of the present invention;

FIG. 4 is a view showing a multimedia service model for portable devices using a set-top box-based hardware transcoder according to an embodiment of the present invention;

FIG. 5 is a view showing the software configuration of a multimedia service system for portable devices using a set-top box-based hardware transcoder according to an embodiment of the present invention; and

FIG. 6 is a view showing the configuration of a real time broadcasting and multimedia service system using a hardware transcoder according to an embodiment of the present invention.

### DESCRIPTION OF THE PREFERRED EMBODIMENTS

Hereinafter, embodiments of the present invention will be described in detail with reference to the attached drawings.

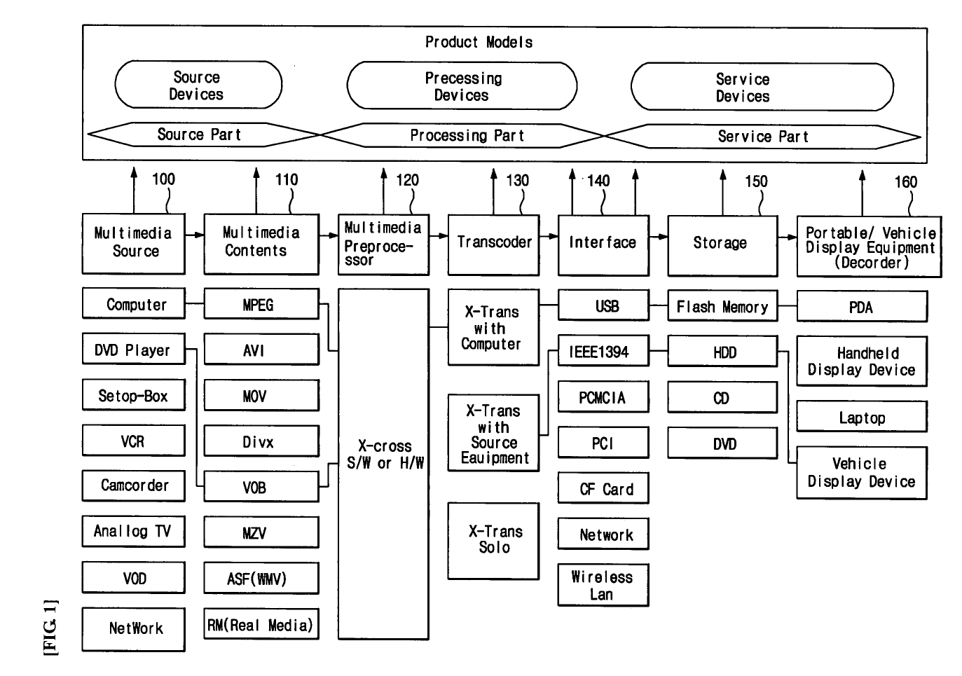

FIG. 1 is a view showing the basic configuration of a multimedia service system for portable devices using a hardware transcoder according to the present invention. The multimedia service system includes a multimedia source 100, multimedia contents 110, a multimedia preprocessor 120, a transcoder 130, an interface 140, a storage unit 150 and a portable device 160.

The multimedia service system for portable devices using a hardware transcoder according to the present invention is constructed so that it converts the multimedia contents 110 provided from the multimedia source into data having a format appropriate to each mobile device. That is, the multimedia contents can be accommodated by the transcoder 130 through the multimedia preprocessor 120, converts the data into multimedia data having a format suitable for the characteristics of the device through the transcoder 130, stores the multimedia data in the storage unit 150 through the interface 140, and then allows a user to be provided with a multimedia service through the portable device 160. In the present specification, such a series of operations is referred to as a “multimedia service process”. In such a multimedia service process, a specific operation may be omitted or a specific device may be excluded. For example, an operation of preprocessing multimedia contents, or the preprocessor 120 therefor may not be necessary if the contents received from the multimedia source are sufficiently suitable for the transcoding or if the transcoder itself performs a preprocessing operation. It is clear that, besides the preprocessing or preprocessor, respective operations of the above-described multimedia service process or respective components for the process may be combined with other operations or components and included therein.

The multimedia source 100 includes all kind of multimedia providing sources including a computer storing multimedia contents in a hard disk, a Digital Versatile Disk (DVD) player, an artificial satellite, a cable receiver, a set-top box, a Video Cassette Recorder (VCR), an analog TV, Video-On-Demand and a wired/wireless network.

The multimedia contents 110 are typically used as contents including audio/video/text, but the multimedia contents in the present invention are focused to audio and video data because text does not require conversion and then does not need to comply with the configuration of the present invention. The multimedia contents 110 are data that are received from the multimedia source 100 and have various formats. For representative examples, the multimedia contents have formats, such as MPEG, AVI, MOV, DAT, VOB, M2V, ASF and RM, and may have other various formats.

The multimedia preprocessor 120 includes software and hardware devices that perform an operation of converting the multimedia contents having various formats according to the multimedia source 100, so as to be suitable for the input format of the transcoder.

The transcoder 130, which is a core hardware device, performs a format converting function of converting the formats of multimedia data (for example, MPEG2→MPEG4), a transrating function of converting a data rate, and a scaling function of converting a resolution. In the present specification, these functions are commonly referred to as “transcoding”, which is used in the attached drawings together with “transcoder” and “X-Trans”. Transcoding can be simultaneously performed with respect to a plurality of pieces of multimedia data.

The interface 140 functions to transmit multimedia data transcoded by the transcoder 130 to the storage unit 150 in the portable device. For the representative interface, there are Universal Serial Bus (USB), Institute of Electrical and Electronics Engineers (IEEE) 1394, and a Wireless Local Area Network (WLAN).

The storage unit 150, which may be a device provided within the portable device 160, or a separate device located at a remote place, receives transcoded multimedia data to allow the portable device to be provided with the multimedia service. For the storage unit 150, a hard disk or flash memory can be representatively used, but the storage unit 150 includes a data maintaining electronic, such register. When the portable device downloads multimedia contents and repeatedly plays the multimedia contents, the multimedia contents should be stored in the hard disk or flash memory. However, if the multimedia contents are only played in real time, there is no need to store the multimedia contents in the hard disk or the like. In order to perform the buffering for real time playing, a partial area of a Random Access Memory (RAM), or an electronic device, such as a register, would be used.

The portable device 160, which is a device including portable/vehicle display equipment, provide the user with a multimedia service while the user carries the device, or while the user drives a vehicle. The portable device 160 may have only a video display function or have additional other functions. For representative examples, the portable device 160 may include a mobile phone, a PDA, a handheld display device, a laptop computer, a notebook computer and a notepad.

A product model, which is type of multimedia service configuration applied to actual products, may be classified into three device models: a source device, a processing device and a service device.

The source device is a device that includes multimedia contents and multimedia sources providing the contents, generates and stores the multimedia contents, and provides the contents to the processing device. The processing device is a device that includes a multimedia preprocessor and a transcoder, transcodes the multimedia contents received from the source device and provides the transcoded multimedia contents to the service device through a suitable interface. The service device is a device that includes a storage unit and a portable device and provides a service of suitably transmitting the multimedia contents received from the processing device to users.

Properly, the three device models can be integrated into a single model, and components included in each device can be arranged differently from the above product model.

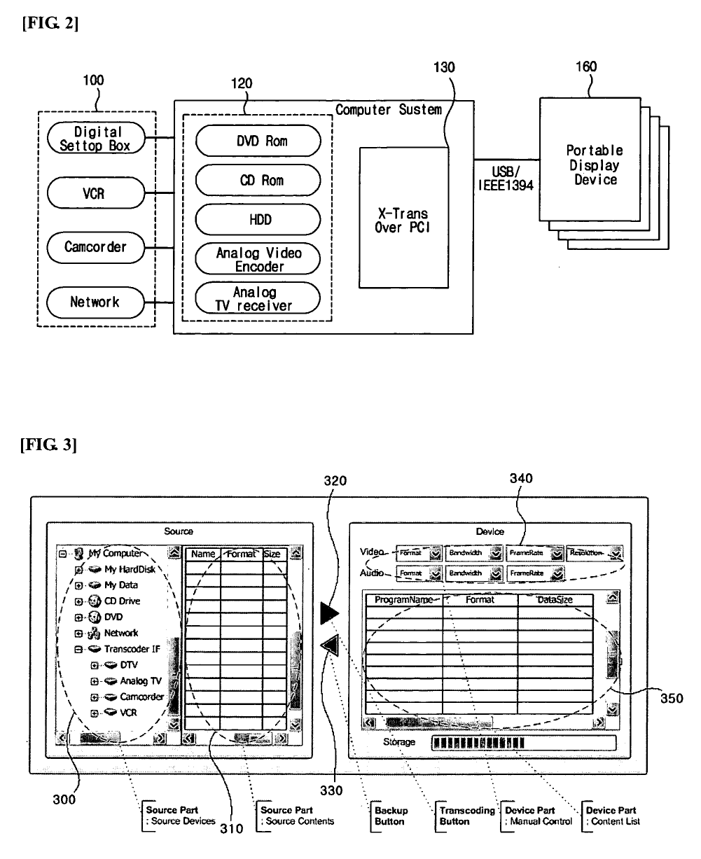

FIGS. 2 to 6 are views showing schemes to which the multimedia service using a hardware transcoder is actually applied according to embodiments of the present invention. The same reference numerals as those of FIG. 1 are used throughout FIGS. 2 to 6 to designate the same or similar components. For example, because X-Trans of FIG. 2 is actually equal to the transcoder of FIG. 1, reference numeral 130 is used to represent the transcoder.

FIG. 2 is a view showing the brief configuration of a multimedia service model for portable devices using a hardware transcoder for computer systems.

The multimedia service model for portable devices using a hardware transcoder for computer systems is the most basic embodiment. A multimedia source 100 may be a user computer, or may be comprised of other devices interfacing with the computer. A processing device 120 and 130 includes hardware having interface module such as Peripheral Component Interconnect (PCI) interface card, a device driver and software for control. A service device is comprised of various types of portable display devices 160 interfacing through a USB, IEEE 1394 bus or the like.

The multimedia service model for portable devices using a hardware transcoder for computer systems is implemented so that the control software intuitively performs all tasks for user's convenience.

FIG. 3 is a view showing the configuration of the Graphic User Interface (GUI) of control software. Referring to the GUI configuration, a source device field 300 of a source part is configured to select a multimedia source 100 interfacing with the inside or outside of the computer. If the multimedia source 100 is selected, multimedia contents that can be obtained from the corresponding multimedia source 100 are shown in a source content field 310 of the source part, by which a user selects desired contents among the shown contents. The X-Trans 130 can simultaneously process a plurality of contents.

Next, a manual operation field 340 of a device part is used to apply a user's desired setting value to the device part, as well as to allow the control software to automatically set a transcoding setting value suitable for the service device. As shown in FIG. 3, the manual operation field 340 is used to set video and audio formats, a bandwidth (data rate), a frame rate, a resolution, etc.

If the above setting operations have been completed, the user store contents, obtained by transcoding selected source contents to correspond to a desired format, bandwidth, frame rate and resolution, in the storage unit 150 by selecting a transcoding button 320. The stored contents are displayed on a content list 350 of the device part and then serviced through the portable device 160.

In the meantime, it is possible to back up the contents stored in the device in a computer. A backup button 330 is used for the backup of the contents.

Although not shown in FIG. 3, the control software of the present invention may include a multimedia edit function, and further include a management function for the device part. The management function for the device part includes a function of ascertaining and considering the display capability of the portable device while interfacing with the portable device, thus more suitably performing the multimedia transcoding.

FIG. 4 is a view showing the configuration of a multimedia service system for portable devices using a set-top box-based hardware transcoder.

The set-top box-based service system can provide a service for broadcasting contents for a live broadcasting channel or broadcasting contents stored in a Personal Video Recorder (PVR). In this case, a multimedia source 100 may be a set-top box 400, or may be comprised of other devices interfacing with the set-top box 400. A processing device includes hardware 410 having interface module such as a PCI interface card, a device driver and software for control. A service device includes various types of display devices interfacing with a network through an Ethernet/WLAN card 420 or the like.

The set-top box and the X-Trans interface with each other in a PCI manner in an embodiment of FIG. 4, however, the present invention is not limited to the embodiment and may include other well-known interfaces or other interfaces to be later developed. Further, for the connection to the network, schemes other than the Ethernet may be adopted.

In the meantime, the set-top box-based display device may be any display device that can be connected to the network, as well as a portable display device. For example, the display device may include a notebook computer used in a Wireless LAN (WLAN) environment or a PC connected to the Internet.

Further, the display device can communicate with respective software modules of a server system through a common interface (CIF) 500 enabling the interaction through the network. Such a communication function allows the display device to personally select required multimedia contents or set required transcoding formats.

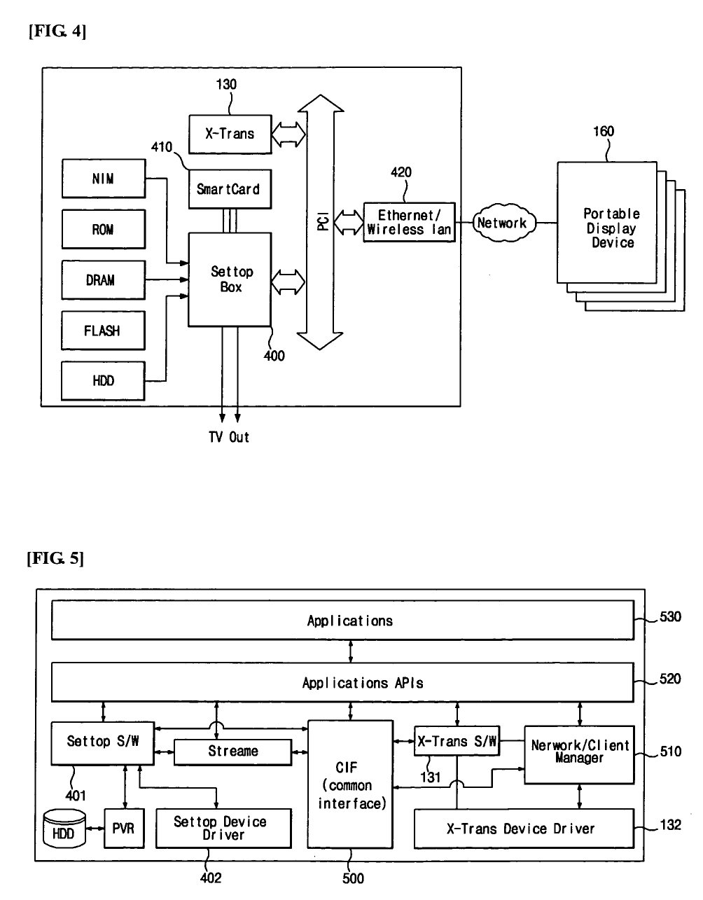

FIG. 5 is a software (S/W) block diagram of a source part. In FIG. 5, set-top box software (S/W) 400 is a S/W package processing the function of the set-top box 400. A streamer functions to transmit streams from the source part to the device part through the network. A Common Interface (CIF) is a part of performing interworking between a plurality of S/W blocks of the source part and the device part. A X-Trans S/W 131 functions to control a transcoder, and a network/client supervisor 510 performs the connection of the network with a plurality of devices of the device part, the maintenance and management of the network connection, the access authorization of the devices, and information management and control. These various S/W blocks can be used in an application program 530 through Application Programming Interfaces (APIs) 520.

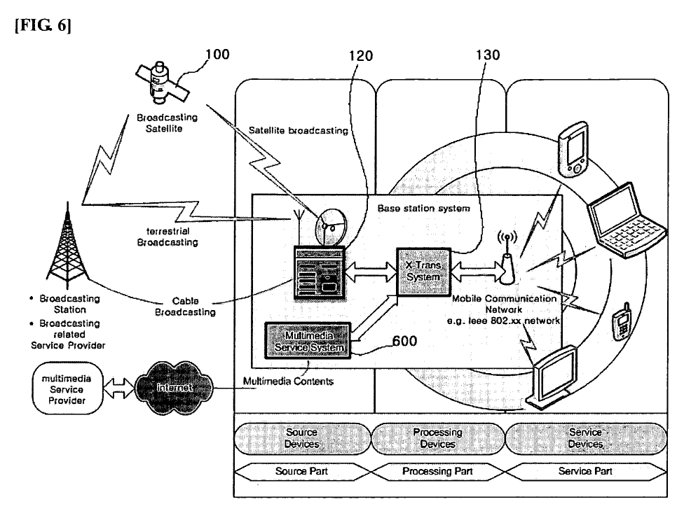

FIG. 6 is a schematic diagram of a real time broadcasting and multimedia service model using a hardware transcoder.

As shown in FIG. 6, the real time broadcasting and multimedia service model using a hardware transcoder is configured so that a broadcasting reception device 120 receives multimedia contents 110 from various multimedia sources 100 including an artificial satellite, a cable and the Internet, and executes preprocessing for the multimedia contents 110, X-Trans 130 transcodes the multimedia contents into multimedia data suitable for a user terminal connected to a base station and provides a real time broadcasting service over a mobile communication network or IEEE 802.xx network, and a multimedia service system 600 transcodes multimedia contents, provided from multimedia service providers through the Internet, into data suitable for the user terminal and then provides a corresponding multimedia service to the user.

In the embodiment, the display devices may be any display devices that can be connected to a mobile communication network and an IEEE 802.xx network, as well as portable display devices. For example, the display device can be applied to a mobile phone or PDA connected to the mobile communication network, a laptop PC used in a WLAN environment, or a device connected to the mobile Internet.

Further, each of the display devices can interact with a base station system through communication link. Such an interaction function enables the display devices to personally select required multimedia contents or set required transcoding formats.

As described above, the present invention provides a multimedia service system for portable devices using a hardware transcoder, which transcodes source multimedia data to be optimized with respect to each display device, thus eliminating unnecessary storage of excessive data in each portable device, and minimizing a need for a high computing capability for the conversion of a resolution and the support of a plurality of formats. Therefore, the present invention simplifies the configuration of a portable device for the playing of multimedia data, and reduces costs of manufacturing the device.

Further, the present invention is advantageous in that it performs rapid transcoding using hardware transcoding technology, thus improving user's convenience and service provider's competitive power, and a hardware transcoder assumes the computation load of a portable display device, thus providing a high quality service using an inexpensive portable device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multimedia service system for providing a multimedia service to at least one portable device, comprising:
a multimedia source providing multimedia contents including video and/or audio data;
a hardware transcoder converting the multimedia contents into contents having a format suitable for a display device of the portable device;
an interface unit transmitting the contents converted by the transcoder;
a storage unit storing therein the contents received through the interface unit; and
the portable device receiving the contents from the storage unit and displaying the contents.

2. The multimedia service system according to claim 2, wherein the transcoder changes at least one of video and/or audio formats, a bandwidth (data rate), a frame rate and a resolution of the contents provided from the multimedia source.

3. The multimedia service system according to claim 1, wherein the portable terminal is a portable multimedia moving image display terminal for portable/vehicle use, including a mobile phone, a notebook computer, a laptop computer, a notepad and a Personal Digital Assistant (PDA).

4. The multimedia service system according to claim 1, further comprising a multimedia preprocessor executing predetermined preprocessing for the contents provided from the multimedia source before the transcoder converts the contents.

5. A multimedia service system for providing a multimedia service to a portable device using a hardware transcoder interworking with a computer, comprising:
a multimedia source providing multimedia contents including video and/or audio data;
the hardware transcoder for the computer converting the multimedia contents into contents having a format suitable for a display device of the portable device;
an interface unit transmitting the contents converted by the transcoder; and
the portable device receiving the contents from the interface unit and displaying the contents.

6. A computer-readable recording medium for storing a control program to provide a multimedia service to a portable device using a hardware transcoder interworking with a computer, wherein:
the control program comprises;
a multimedia source selection code adapted to select a multimedia source,
a multimedia content selection code adapted to select at least one of a plurality of contents provided from the multimedia source,
a conversion code adapted to convert the contents, and
a display code adapted to display the contents converted by the conversion code.

7. The computer-readable recording medium according to claim 6, wherein the conversion code changes at least one of video and/or audio formats, a bandwidth (data rate), a frame rate and a resolution of the contents provided from the multimedia source.

8. The computer-readable recording medium according to claim 6, wherein the control program further comprises a code to perform a multimedia edit function and a portable device management function.

9. A multimedia service system for providing a multimedia service to a portable device using a hardware transcoder interworking with a set-top box, comprising:
a multimedia source providing multimedia contents including video and/or audio data;
the hardware transcoder for the set-top box converting the multimedia contents into contents having a format suitable for a display device of the portable device;
an interface unit transmitting the contents converted by the transcoder; and
the portable device receiving the contents from the interface unit and displaying the contents.

10. The multimedia service system according to claim 9, wherein the interface unit includes an Ethernet or Wireless Local Area Network (WLAN) card and other similar communication devices.

11. The multimedia service system according to claim 9, wherein the set-top box and the transcoder are connected to each other in a Peripheral Component Interconnect (PCI) manner or other similar connection manners.

12. A multimedia service system for providing a device-optimized multimedia service using a hardware transcoder, comprising:
a multimedia source providing multimedia contents including video and/or audio data;
a hardware transcoder converting the contents into contents having formats suitable for display capabilities of portable and fixed devices in real time; and
an interface unit transmitting the contents converted by the transcoder so as to be suitable for the portable device in real time.

13. The multimedia service system according to claim 12, further comprising a multimedia service server transmitting the contents converted by the transcoder so as to be suitable for the fixed device.

14. The multimedia service system according to claim 12, wherein the interface unit includes an IEEE 802.xx and other mobile communication networks.

15. The multimedia service system according to claim 13, wherein the multimedia service server provides the converted multimedia contents to a multimedia service provider (MSP) through the Internet.
